(19) United States
(12) Patent Application Publication
(10) Pub. No.: US 2015/0088640 A1
(43) Pub. Date: Mar. 26, 2015

(54) VOICE TO TEXT CONVERSION

(71) Applicant: Jayson Lee WRIGHT, Cronulla NSW (AU)

(72) Inventor: Jayson Lee WRIGHT, Cronulla NSW (AU)

(21) Appl. No.: 14/466,552

(22) Filed: Aug. 22, 2014

(30) Foreign Application Priority Data
Aug. 23, 2013 (AU) 2013903201

(51) Int. Cl. G06Q 30/02; G10L 15/00

(52) U.S. Cl. CPC G06Q 30/0251; G10L 15/00
USPC 705/14.49

(57) ABSTRACT

A method of generating an event on a digital device; the event derived from a cycle of communication between the digital device and at least one other digital device; the method comprising recording at least a portion of the cycle of communication on the digital device; processing the at least a portion of the cycle of communication thereby to generate at least one event signal; comparing the event signal with one or more available events and selecting an event which best matches with the event signal; and executing the event on the digital device. Also disclosed is a system for generating an event on a digital device.

### BACKGROUND

Customized advertising is well known in the art. The practice of analyzing text, determining keywords and delivering advertising based on the content is a mainstay of current advertising based system such as Google online advertising.

While there is a large volume of content that is available for analysis and conversion into advertising opportunities there are some forms of content that need further processing before they can be used in this manner.

For example since audio such as phone calls and people talking are not in text form they are not in themselves available for conversion into advertising opportunities.

Systems for converting audio and spoken word are available but have not been integrated with applications that allow relevant and value driven advertising to be shown to the user as the spoken or other audio content is produced.

The described invention is designed to address these issues.

Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### BRIEF DESCRIPTION OF INVENTION

Accordingly in one broad form of the invention there is provided a method of generating an event on a digital device; the event derived from a cycle of communication between the digital device and at least one other digital device; said method comprising:

recording at least a portion of the cycle of communication on the digital device;

processing the at least a portion of the cycle of communication thereby to generate at least one event signal;

comparing the event signal with one or more available events and selecting an event which best matches with the event signal;

executing the event on the digital device.

Preferably the event is an advertisement.

Preferably the step of processing includes applying speech recognition thereby to generate word data.

Preferably one or more words from the word data are associated with an event.

Preferably the step of association is performed by means of a lookup table.

Preferably the cycle of communication comprises voice communication.

Preferably the step of processing is carried out on the digital device.

Preferably the step of processing is carried out on a processor located remote from the digital device.

Preferably the digital device communicates with the processor in part via the mobile telecommunications system.

Preferably the digital device communicates with the processor in part via the Internet.

Preferably data recorded by said step of recording is stored on said digital device.

Preferably data recorded by said step of recording is retained only for a predetermined period of time and then deleted.

In yet a further broad form of the invention there is provided a system for generating an event on a digital device; the event derived from a cycle of communication between the digital device and at least one other digital device; said system comprising

a recording device which records at least a portion of the cycle of communication on the digital device;

a processing device which processes the at least a portion of the cycle of communication thereby to generate at least one event signal;

a comparing devices which compares the event signal with one or more available events and selecting an event which best matches with the event signal;

an event execution processor which executes the event on the digital device.

Preferably the event is an advertisement.

Preferably the step of processing includes applying speech recognition thereby to generate word data.

Preferably one or more words from the word data are associated with an event.

Preferably the step of association is performed by means of a lookup table.

Preferably the cycle of communication comprises voice communication.

Preferably the step of processing is carried out on the digital device.

Preferably the step of processing is carried out on a processor located remote from the digital device.

Preferably the digital device communicates with the processor in part via the mobile telecommunications system.

Preferably the digital device communicates with the processor in part via the Internet.

Preferably data recorded by said step of recording is stored on said digital device.

Preferably data recorded by said step of recording is retained only for a predetermined period of time and then deleted.

In yet a further broad form of the invention there is provided media having program steps recorded thereon which, when executed by a digital processor, perform the method described above.

### DRAWINGS

Embodiments of the invention will now be described with reference to the accompanying drawings wherein:

FIG. 1—Main components of the example embodiment

FIG. 2—Interaction example between users and the example embodiment

FIG. 3—A control process for the example embodiment

### DESCRIPTION AND OPERATION

An example embodiment of the invention discloses an application that allows users of mobile phones to talk to each other and at the same time have keyword and key expression generated relevant advertising pushed to them as a result of their spoken conversation.

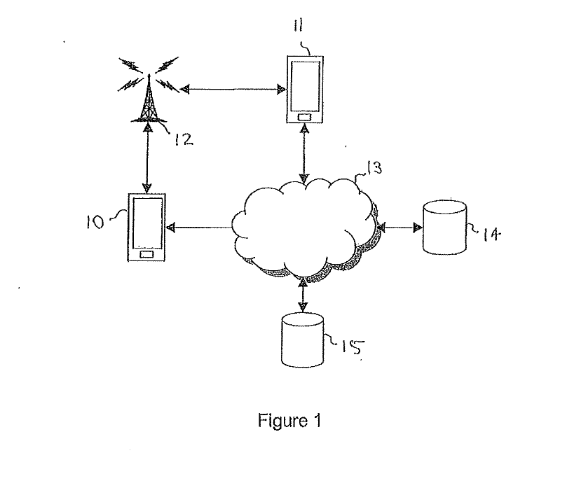

FIG. 1 shows the main components of the example embodiment comprising an initiating user's device 10 that starts a call across the cellular network 12 to a receiving user's device 11.

An application on each of the devices 10 11 manages the call and also connects the users 10 11 to a voice to text application 14 over the internet 13.

In this embodiment the voice to text conversion is a private service that does the audio to text conversion and then sends the converted text back to the user 10 11 with a set of keywords derived from the converted speech. The text is not stored in this case. In the example embodiment it is assumed that the user's 10 11 have chosen to maintain their privacy and not have the text version of their conversation stored.

Subsequently an interaction occurs between the users devices 10 11 and an advertising service 15 where key words and expressions are derived from the converted speech and used to select advertising and or related information that may be of use to the users 10 11 in the context of their conversation.

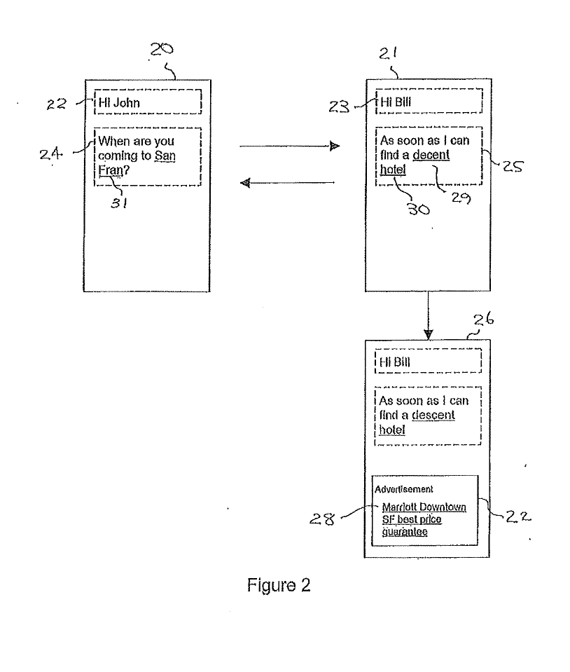

FIG. 2 discloses an example of part of a conversation between two users who are using the example embodiment. The initiating user 20 initiates the call with the receiving user 21 and conversation starts 22. The receiving user responds 23 and subsequently a text representation 22 23 24 25 is displayed to the users as their respective segments of speech are converted to text and sent back to the users respective screens.

During the conversation keywords 29 30 emerge that can be analyzed and submitted to an advertising service that would in turn deliver advertising 22 back to the user that may be of interest or useful to the user.

In this example the keywords “decent” 29 and “hotel” 30 in the context of a location namely “San Fran” 31 means that an advertisement 22 for a hotel in San Francisco 28 may have a high likelihood of being helpful to the users in the conversation.

The result of this process is that relevant advertising is presented to the users based on their conversation using a conversion of their speech into text that is searched for key words and expressions.

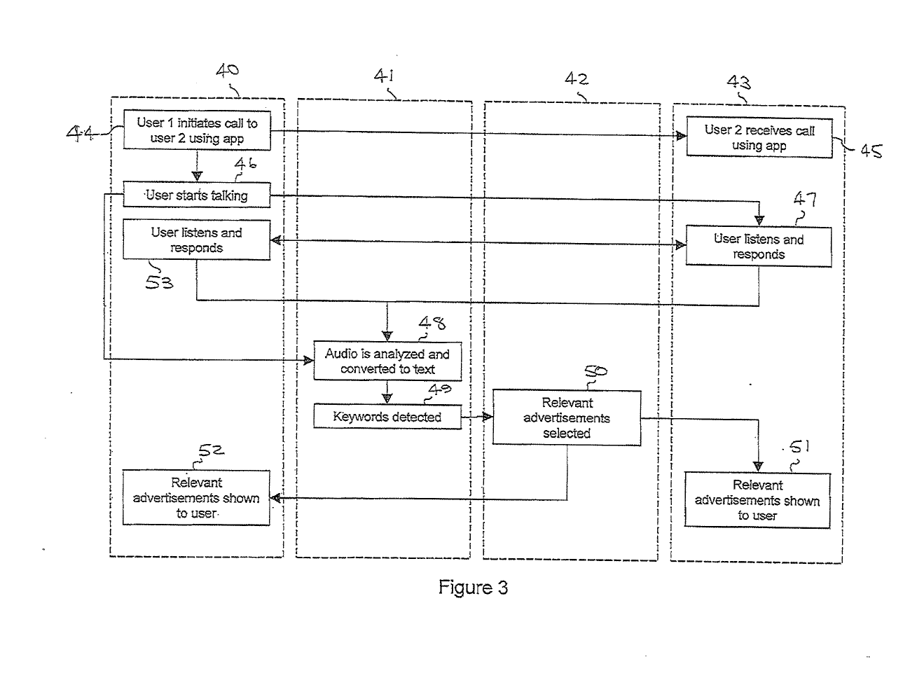

FIG. 3 discloses a control process of the example embodiment. This process comprises an initiating user device 40, a receiving user and device 43, a speech to text conversion service 41, and an advertising selection and submission service 42.

The initiating user 44 starts a call with the receiving user 45. Both of the users are using an application on their devices that records speech and routes it as needed.

The initiating user starts talking 46 and a cycle of listening and responding on the behalf of both the initiating user 53 and the responding user 47 are conducted until the conversation ends and the users terminate the call.

During the cycle of conversation 46 47 53, the monitored speech of the conversation is sent to a speech to text service 41 for analysis and conversion into text 48.

The text may be returned to the users for viewing on their respective devices 40 43. From the converted text 48 key words and expressions are analyzed 49 and these are submitted to an advertising selection and submission service 42 where relevant advertisements are selected 50.

In the example embodiment, the keywords are returned to the users devices 40 43 and then resent to the advertising selection and submission service 42.

Once relevant advertisements are selected 50 based on the keywords and expressions made by the users, the relevant advertisements are shown to each user 52 51 on their own devices 43 40.

The result is a voice to text based advertising selection system that uses converted spoken conversation to select relevant advertising to be displayed to the persons in the conversation.

### ALTERNATIVE EMBODIMENTS

The example embodiment discloses two people in a conversation using mobile phones and an application on each device that links the conversation to a speech to text service over the Internet and the redirection of keywords and expressions from that conversion to an advertising service that displays relevant advertising to the users of the devices during or after their conversation.

An alternative embodiment could involve any number of members of a conversation on unlimited number of devices, where the speech can be in the form of real time conversation between people or recorded speech. An alternative embodiment could complete the speech to text using an application on the user's device rather than on a service accessed over the Internet.

An alternative embodiment may use surrogate keywords or category type identifiers to select relevant advertisements in the event the user does not want to share actual keywords or parts of their conversation with the advertising server.

The example embodiment uses a remote service to conduct the speech to text conversion capability and the resulting conversion is deleted once the converted text has been returned to the user. An alternative embodiment could store for a time or indefinitely store and archive conversations made by the user at the user's discretion.

The example embodiment uses key words and expressions to generate relevant advertising that is shown to the user. An alternative embodiment could use key words and expressions to generate links to non advertising based information such as links to locations on a map or a link to a persons contact details on the phone.

In preferred forms the event may be displayed after the cycle of communication terminates.

1. A method of generating an event on a digital device; the event derived from a cycle of communication between the digital device and at least one other digital device; said method comprising
recording at least a portion of the cycle of communication on the digital device;
processing the at least a portion of the cycle of communication thereby to generate at least one event signal;
comparing the event signal with one or more available events and selecting an event which best matches with the event signal;
executing the event on the digital device.

2. The method of claim 1 wherein the event is an advertisement.

3. The method of claim 1 wherein the step of processing includes applying speech recognition thereby to generate word data.

4. The method of claim 1 wherein one or more words from the word data are associated with an event.

5. The method of claim 4 wherein the step of association is performed by means of a lookup table.

6. The method of claim 1 wherein the cycle of communication comprises voice communication.

7. The method of claim 1 wherein the step of processing is carried out on the digital device.

8. The method of claim 1 wherein the step of processing is carried out on a processor located remote from the digital device.

9. The method of claim 8 wherein in the digital device communicates with the processor in part via the mobile telecommunications system.

10. The method of claim 8 wherein the digital device communicates with the processor in part via the Internet.

11. The method of claim 1 wherein data recorded by said step of recording is stored on said digital device.

12. The method of claim 1 wherein data recorded by said step of recording is retained only for a predetermined period of time and then deleted.

13. The method of claim 1 wherein said digital device comprises a smart phone.

14. The method of claim 1 wherein said at least one other digital device comprises a digital television.

15. The method of claim 1 wherein said at least one other digital device comprises a smartphone.

16. A system for generating an event on a digital device; the event derived from a cycle of communication between the digital device and at least one other digital device; said system comprising
a recording device which records at least a portion of the cycle of communication on the digital device;
a processing device which processes the at least a portion of the cycle of communication thereby to generate at least one event signal;
a comparing devices which compares the event signal with one or more available events and selecting an event which best matches with the event signal;
an event execution processor which executes the event on the digital device.

17. The system of claim 16 wherein the event is an advertisement.

18. The system of claim 16 wherein the step of processing includes applying speech recognition thereby to generate word data.

19. The system of claim 16 wherein one or more words from the word data are associated with an event.

20. The system of claim 19 wherein the step of association is performed by means of a lookup table.

21. The system of claim 16 wherein the cycle of communication comprises voice communication.

22. The system of claim 16 wherein the step of processing is carried out on the digital device.

23. The system of claim 16 wherein the step of processing is carried out on a processor located remote from the digital device.

24. The system of claim 16 wherein in the digital device communicates with the processor in part via the mobile telecommunications system.

25. The system of claim 16 wherein the digital device communicates with the processor in part via the Internet.

26. The system of claim 16 wherein data recorded by said step of recording is stored on said digital device.

27. The system of claim 16 wherein data recorded by said step of recording is retained only for a predetermined period of time and then deleted.

28. The system of claim 16 wherein said digital device comprises a smart phone.

29. The system of claim 16 wherein said at least one other digital device comprises a digital television.

30. Media having program steps recorded thereon which, when executed by a digital processor, perform the method of claim 1.
